(19) United States
(12) Patent Application Publication
(10) Pub. No.: US 2012/0005562 A1
(43) Pub. Date: Jan. 5, 2012

(54) ENCODED STREAM DECODING DEVICE

(75) Inventors: Futoshi MORIE, Osaka (JP); Shuji MIYASAKA, Osaka (JP); Kazushi KURATA, Osaka (JP); Yosuke KUDO, Osaka (JP)

(73) Assignee: Panasonic Corporation, Osaka (JP)

(21) Appl. No.: 13/234,830

(22) Filed: Sep. 16, 2011

Related U.S. Application Data
(63) Continuation of application No. PCT/JP2009/004878, filed on Sep. 25, 2009.

(30) Foreign Application Priority Data
Apr. 27, 2009 (JP) 2009-108080

(51) Int. Cl. G06F 11/07

(52) U.S. Cl. 714/799; 714/E11.024

(57) ABSTRACT

In an encoded stream decoding device, a storage amount checking circuit confirms that a sufficient amount of stream has been stored in a buffer circuit. Thereafter, a control circuit starts repeatedly outputting a control signal to a decoding circuit to instruct the decoding circuit to perform a variable-length decoding process. If, by iterating the decoding process, the total amount of a consumed stream in the buffer circuit 11 is caused to be higher than or equal to a threshold set in a threshold setting circuit, a disabling circuit generates a decoding disable signal having a value of “1,” and outputs the decoding disable signal to the control circuit. When receiving the decoding disable signal, the control circuit outputs, to the decoding circuit, a control signal for instructing to stop the decoding process, so that the decoding circuit stops the decoding process.

### CROSS-REFERENCE TO RELATED APPLICATIONS

This is a continuation of PCT International Application PCT/JP2009/004878 filed on Sep. 25, 2009, which claims priority to Japanese Patent Application No. 2009-108080 filed on Apr. 27, 2009. The disclosures of these applications including the specifications, the drawings, and the claims are hereby incorporated by reference in their entirety.

### BACKGROUND

The present disclosure relates to signal processing devices which handle stream data, and more particularly, to devices which decode encoded streams containing variable-length encoded data.

As digital signal processing technology has progressed, a variety of devices which record and reproduce audio/video (AV) signals containing audio and video using a storage medium, such as a DVD, a BD, an SD memory card, etc., have been developed and used in various applications. Also, devices which transmit and receive AV signals via broadcasting waves or a digital network are gaining widespread use. In such applications, a complicated encoding technique is used in order to record and produce a high-quality AV signal. Therefore, these processes require a large amount of computation and a complicated control. On the other hand, however, in actual use, the processes need to be performed in consideration of the possibility that an error occurs in an AV signal during read/write operation of a storage medium or transmission/reception.

Conventionally, Japanese Patent Publication No. 2002-185332 (pp. 3-11, FIG. 1, etc.) describes a variable-length code decoding device which can easily detect an error, if any, which occurs in a bit stream to be decoded.

As shown in FIG. 13, the variable-length code decoding device includes a first storage 1, a decoder 2, a timer 3, and a controller 4. The first storage 1 stores received variable-length encoded data. The decoder 2 decodes a Huffman code read from the first storage 1. The timer 3 outputs a time-out signal after a predetermined period of time has elapsed since the start of decoding by the decoder 2. The controller 4 forcibly terminates decoding performed by the decoder 2 based on the time-out signal from the timer 3.

With such a configuration, if it takes a predetermined period of time or more to complete a decoding process due to an error occurring in a variable-length code, the decoding process performed by a decoder is forcibly terminated based on a time-out signal from a timer. As a result, an error occurring in a variable-length code is detected, and frame loss and audio loss which are caused by excessive decoding time is reduced.

However, in the conventional configuration, if an error occurs in a variable-length code, a process does not proceed for a predetermined period of time until a time-out signal is generated. As the speed of a system is increased, the time-out period relatively increases. Therefore, in a system requiring high-speed processing, the influence of the time-out period is significant.

In a system in which the bit rate is not constant or a plurality of processes are simultaneously performed, if, for example, a resource conflict occurs, the processing time fluctuates. In the conventional configuration, if the processing time fluctuates, the time-out period needs to be set based on the longest processing time. Therefore, in a system in which a complicated process needs to be performed, the time-out period is disadvantageously long.

### SUMMARY

The present disclosure describes implementations of an encoded stream decoding device which can efficiently detect an error in a system in which a high-speed and complicated process is required.

In the present disclosure, an error in a stream is detected based on the total amount of a consumed stream which has been decoded or the number of iterations of a decoding process, whereby it is not necessary to invariably wait for a long time-out period.

Specifically, an encoded stream decoding device includes a buffer section configured to store an external input stream, a decoding section configured to variable-length decode the stream stored in the buffer section, a control section configured to generate a control signal for controlling operation of the decoding section, and output the control signal to the decoding section, a threshold setting section configured to store a threshold for a stream consumed by the decoding section, and a disabling section configured to generate a decoding disable signal based on the threshold in the threshold setting section and the amount of the stream consumed by the decoding section, and output the decoding disable signal to the control section.

The example encoded stream decoding device may further include a storage amount checking section configured to confirm that a sufficient amount of stream for the threshold stored by the threshold setting section has been stored in the buffer section. The control section may cause the decoding section to wait until the storage amount checking section confirms that the sufficient amount of stream for the threshold stored by the threshold setting section has been stored in the buffer section.

In the example encoded stream decoding device, the control section, when receiving the decoding disable signal from the disabling section, may stop decoding operation of the decoding section using the control signal. The decoding section, when the disabling section is generating the decoding disable signal, may stop a decoding process based on the control signal from the control section, so that the decoding section does not consume the stream.

In the example encoded stream decoding device, the control section, even when receiving the decoding disable signal from the disabling section, may generate a control signal which causes the decoding section to continue decoding. The decoding section may receive the decoding disable signal generated by the disabling section, and behave as if the decoding section received the control signal generated by the control section and operated based on the control signal, for the control section, when the decoding section is receiving the decoding disable signal.

In the example encoded stream decoding device, when the decoding section is receiving the decoding disable signal from the disabling section, the decoding section may not perform a decoding process, and may generate a special value as a decoding result and output the decoding result having the special value to the control section.

In the example encoded stream decoding device, the decoding section may reduce power consumption by shutting down a clock or the like when the decoding section is receiving the decoding disable signal.

In the example encoded stream decoding device, the control section, after ending a task including a series of decoding processes, may determine whether or not the disabling section is generating the decoding disable signal, and when the disabling section is generating the decoding disable signal, may perform a control for returning.

The example encoded stream decoding device may further include a state storage section configured to be notified of a difference between the threshold in the threshold setting section and the total amount of a stream consumed by the decoding section, by the disabling section, and also notified of a state of a stream in the buffer section by the buffer section. After a decoding process is interrupted in the decoding section, when the interrupted decoding process is resumed, the state storage section may notify the threshold setting section of the difference between the threshold and the total consumed stream amount as a new threshold, and restore the stream state in the buffer section.

In the example encoded stream decoding device, the state storage section may change the difference between the threshold and the total consumed stream amount and notify the threshold setting section of the difference, and may change the stream state in the buffer section so that the stream state corresponds to the changed difference, thereby rewinding or skipping the stream.

The example encoded stream decoding device may further include a second control section configured to generate a second control signal for controlling the decoding section, and outputs the second control signal to the decoding section. The decoding section may perform a decoding process based on a control signal from the second control section when the decoding section is receiving the decoding disable signal from the disabling section.

In the example encoded stream decoding device, the control section may control a plurality of tasks in parallel. The decoding section, when performing a decoding process based on one of the plurality of tasks, may perform a decoding process of another task when the decoding section is receiving the decoding disable signal from the disabling section.

Another example encoded stream decoding device includes a buffer section configured to store an external input stream, a decoding section configured to variable-length decode the stream stored in the buffer section, a control section configured to generate a control signal for controlling operation of the decoding section, and output the control signal to the decoding section, a threshold setting section configured to store a threshold for the number of times of generation of the control signal by the control section, and a disabling section configured to generate a decoding disable signal based on the threshold in the threshold setting section and the number of times of generation of the control signal by the control section, and output the decoding disable signal to the control section.

The example encoded stream decoding device may further include a storage amount checking section configured to confirm that a predetermined amount of stream has been stored in the buffer section. The control section may cause the decoding section to wait until the storage amount checking section confirms that the predetermined amount of stream has been stored in the buffer section.

In the example encoded stream decoding device, the control section, when receiving the decoding disable signal from the disabling section, may stop decoding operation of the decoding section based on the control signal. The decoding section, when the disabling section is generating the decoding disable signal, may receive the control signal from the control section and stop a decoding process, so that the decoding section does not consume the stream.

As described above, according to the present disclosure, in a task of performing a series of decoding processes, the amount of a consumed stream which has been decoded is accumulated every time the decoding process is performed. If the total amount of a consumed stream exceeds the threshold in the threshold setting section, or if the number of times of generation of the control signal by the control section (i.e., the number of iterations of the decoding process) exceeds the threshold in the threshold setting section, the disabling section immediately generates the decoding disable signal. Therefore, an error in a stream is immediately detected without the occurrence of a waiting time.

In particular, in the present disclosure, even if an external input stream is slowed or interrupted after the start of a decoding process, an underflow does not occur in the buffer section until the disabling section generates the decoding disable signal.

In the present disclosure, when the disabling section generates the decoding disable signal, the decoding section stops consuming a stream. Therefore, even if an external input stream is slowed or interrupted after the generation of the decoding disable signal, an underflow does not occur in the buffer section.

In the present disclosure, it is not necessary for the control section to determine whether or not the decoding disable signal has been generated or whether or not an underflow has occurred in the buffer section every time the decoding process is performed. Therefore, the control performed by the control section is facilitated.

In the present disclosure, when the decoding disable signal is generated, the decoding section outputs a special value (e.g., “0”) as the decoding result. Therefore, when an audio signal is processed, then even if the decoding disable signal is generated, the output may be caused to be silent, for example. Therefore, the occurrence of noise due to an error in a stream is reduced or prevented without the need of an exceptional process performed by the control section.

In the present disclosure, the control section does not perform error detection every time the decoding process is performed. Instead, after a series of successive decoding processes are completely performed, the control section determines whether or not the disabling section has generated the decoding disable signal, and performs a return process when necessary. Therefore, the control performed by the control section for each decoding process is facilitated, and error detection and a return process can be performed at predetermined intervals.

In the present disclosure, the state storage section stores the difference between the threshold and the total consumed stream amount, and the stream state in the buffer section. Therefore, a task including a series of successive decoding processes may be temporarily interrupted, and another task or a decoding process of another stream may be performed before the interrupted task may be resumed.

In the present disclosure, when the interrupted task is resumed, the difference between the threshold and the total consumed stream amount is changed from the original value, and the stream state in the buffer section is changed based on the difference, whereby the stream can be rewound or skipped.

In the present disclosure, if the control section processes a plurality of tasks or when there is a plurality of the control sections, then when the decoding disable signal is generated, another task or another control section can use the decoding section.

As described above, according to the encoded stream decoding device of the present disclosure, an error in a stream can be detected without waiting for a long time. Therefore, a relative waiting time until an error is detected can advantageously be reduced even in a high-speed decoding system, a multitask system, or a codec having an inconstant bit rate.

### BRIEF DESCRIPTION OF THE DRAWINGS

FIG. 1 is a block diagram showing a configuration of an encoded stream decoding device according to a first embodiment of the present disclosure.

FIG. 2 is a flowchart showing an example process performed by the encoded stream decoding device of FIG. 1.

FIG. 3 is a block diagram showing a configuration of an encoded stream decoding device according to a second embodiment of the present disclosure.

FIG. 4 is a flowchart showing an example process performed by the encoded stream decoding device of FIG. 3.

FIG. 5 is a block diagram showing a configuration of an encoded stream decoding device according to a third embodiment of the present disclosure.

FIG. 6 is a flowchart showing an example process performed by the encoded stream decoding device of FIG. 5.

FIG. 7 is a block diagram showing a configuration of an encoded stream decoding device according to a fourth embodiment of the present disclosure.

FIG. 8 is a flowchart showing an example process performed by the encoded stream decoding device of FIG. 7.

FIG. 9 is a block diagram showing a configuration of an encoded stream decoding device according to a fifth embodiment of the present disclosure.

FIG. 10 is a block diagram showing another configuration of the encoded stream decoding device of FIG. 9.

FIG. 11 is a block diagram showing a configuration of an encoded stream decoding device according to a sixth embodiment of the present disclosure.

FIG. 12 is a diagram showing an example encoding table.

FIG. 13 is a block diagram showing a configuration of a conventional variable-length code decoding device.

### DETAILED DESCRIPTION

Encoded stream decoding devices according to embodiments of the present disclosure will be described with reference to the accompanying drawings.

### First Embodiment

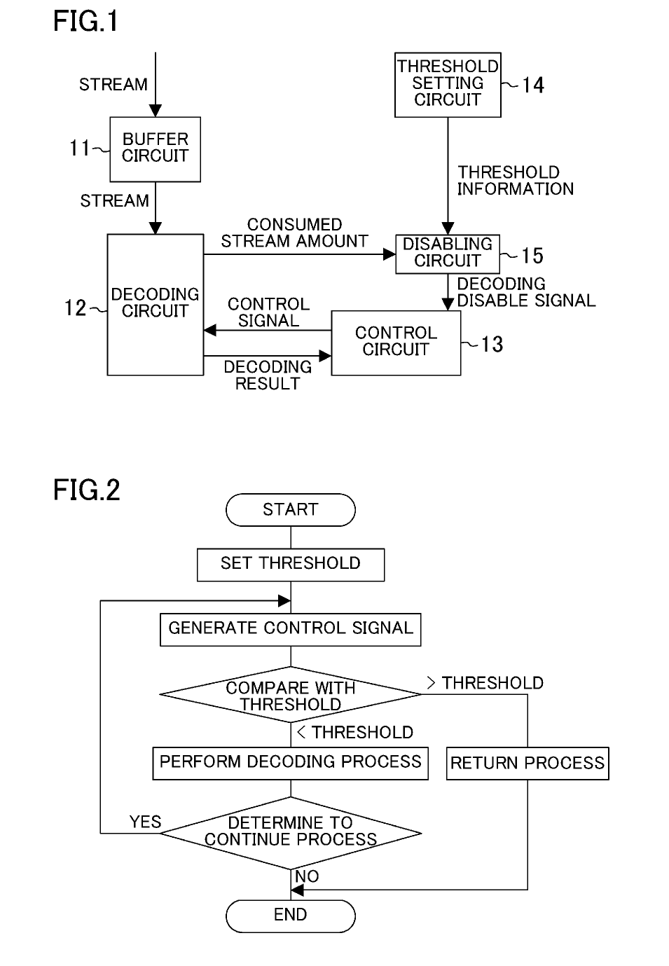

FIG. 1 is a block diagram showing a configuration of an encoded stream decoding device according to a first embodiment of the present disclosure.

The encoded stream decoding device of FIG. 1 includes a buffer circuit 11, a decoding circuit 12, a control circuit 13 including, for example, a processor, a threshold setting circuit 14, and a disabling circuit 15. The encoded stream decoding device variable-length decodes an external input stream.

The buffer circuit (buffer section) 11 stores an external input stream for the preparation of a decoding process. The decoding circuit (decoding section) 12 variable-length decodes a stream input from the buffer circuit 11 based on a control signal, and outputs the decoding result and information about the amount of a stream consumed during the decoding process.

The control circuit (control section) 13 performs various controls of decoding operation of the decoding circuit 12. A series of operations performed by the control circuit 13 is hereinafter referred to as a task. In a task for decoding, the control circuit 13 repeatedly performs operation of generating a control signal for controlling the decoding circuit 12 and receiving the result of decoding performed by the decoding circuit 12. The control signal is generated by, for example, determining the next control signal based on a stream which has been previously input, or decoding the header of a stream.

The threshold setting circuit (threshold setting section) 14 outputs, to the disabling circuit 15, a threshold which has been set therein externally or by the control circuit 13 before the start of a decoding process. The disabling circuit (disabling section) 15 calculates the total amount of a consumed stream output from the decoding circuit 12, and when the total amount exceeds the threshold output from the threshold setting circuit 14, enables the decoding disable signal. Specifically, if the total amount of a consumed stream is lower than or equal to the threshold, “0” is output as the decoding disable signal, and if the total amount of a consumed stream is higher than the threshold, “1” is output as the decoding disable signal.

Operation of variable-length decoding an encoded stream “0110010101111111” based on an encoding table shown in FIG. 12 will be described. FIG. 2 shows a flow of a decoding process based on this configuration.

Initially, the threshold setting circuit 14 stores a threshold received externally or from the control circuit 13. Here, it is assumed that a stream having a length of 16 bits is externally input, and a “threshold” which is equal to the total amount of a consumed stream in a normal condition (free from an error) is set to be “16” bits. Next, the control circuit 13 starts iterating a decoding process. The control circuit 13 is assumed to previously know that the decoding process will be completed by six iterations of the decoding process, based on, for example, the analysis of the header of a stream, or a standard.

First time: after confirming that the buffer circuit 11 does not have an underflow condition, the control circuit 13 generates a control signal for decoding a variable-length code. The decoding circuit 12 reads a leading portion of the stream in the buffer circuit 11, and outputs “1” which is the length of “0” as a consumed stream amount to the disabling circuit 15. The disabling circuit 15 compares the total consumed stream amount of “1” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs a decoding result “a” to the control circuit 13. The control circuit 13 confirms that the decoding disable signal is “0” and continues the process.

Second time: after confirming that the buffer circuit 11 does not have an underflow condition, the control circuit 13 generates a control signal for decoding a variable-length code. The decoding circuit 12 reads a leading portion of the stream in the buffer circuit 11, and outputs “3” which is the length of “110” as a consumed stream amount to the disabling circuit 15. The disabling circuit 15 compares the total consumed stream amount of “4” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs a decoding result “c” to the control circuit 13. The control circuit 13 confirms that the decoding disable signal is “0” and continues the process.

Third time: after confirming that the buffer circuit 11 does not have an underflow condition, the control circuit 13 generates a control signal for decoding a variable-length code. The decoding circuit 12 reads a leading portion of the stream in the buffer circuit 11, and outputs “1” which is the length of “0” as a consumed stream amount to the disabling circuit 15. The disabling circuit 15 compares the total consumed stream amount of “5” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “a” to the control circuit 13. The control circuit 13 confirms that the decoding disable signal is “0” and continues the process.

Fourth time: after confirming that the buffer circuit 11 does not have an underflow condition, the control circuit 13 generates a control signal for decoding a variable-length code. The decoding circuit 12 reads a leading portion of the stream in the buffer circuit 11, and outputs “2” which is the length of “10” as a consumed stream amount to the disabling circuit 15. The disabling circuit 15 compares the total consumed stream amount of “7” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs a decoding result “b” to the control circuit 13. The control circuit 13 confirms that the decoding disable signal is “0” and continues the process.

Fifth time: after confirming that the buffer circuit 11 does not have an underflow condition, the control circuit 13 generates a control signal for decoding a variable-length code. The decoding circuit 12 reads a leading portion of the stream in the buffer circuit 11, and outputs “2” which is the length of “10” as a consumed stream amount to the disabling circuit 15. The disabling circuit 15 compares the total consumed stream amount of “9” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “b” to the control circuit 13. The control circuit 13 confirms that the decoding disable signal is “0” and continues the process.

Sixth time: after confirming that the buffer circuit 11 does not have an underflow condition, the control circuit 13 generates a control signal for decoding a variable-length code. The decoding circuit 12 reads a leading portion of the stream in the buffer circuit 11, and outputs “7” which is the length of “1111111” as a consumed stream amount to the disabling circuit 15. The disabling circuit 15 compares the total consumed stream amount of “16” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs a decoding result “h” to the control circuit 13.

Next, a case where an erroneous stream “0110010111111111(0)” is input will be described. Here, the 17th bit is a stream following an original stream to be decoded.

Initially, the threshold setting circuit 14 stores a threshold received externally or from the control circuit 13. It is assumed that a stream having a length of 16 bits is externally input, and the value of “16” is set as the threshold. Next, the control circuit 13 starts iterating a decoding process.

First time: after confirming that the buffer circuit 11 does not have an underflow condition, the control circuit 13 generates a control signal for decoding a variable-length code. The decoding circuit 12 reads a leading portion of the stream in the buffer circuit 11, and outputs “1” which is the length of “0” as a consumed stream amount to the disabling circuit 15. The disabling circuit 15 compares the total consumed stream amount of “1” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “a” to the control circuit 13. The control circuit 13 confirms that the decoding disable signal is “0” and continues the process.

Second time: after confirming that the buffer circuit 11 does not have an underflow condition, the control circuit 13 generates a control signal for decoding a variable-length code. The decoding circuit 12 reads a leading portion of the stream in the buffer circuit 11, and outputs “3” which is the length of “110” as a consumed stream amount to the disabling circuit 15. The disabling circuit 15 compares the total consumed stream amount of “4” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “c” to the control circuit 13. The control circuit 13 confirms that the decoding disable signal is “0” and continues the process.

Third time: after confirming that the buffer circuit 11 does not have an underflow condition, the control circuit 13 generates a control signal for decoding a variable-length code. The decoding circuit 12 obtains a stream “0” from the buffer circuit 11, and outputs a consumed stream amount of “1” to the disabling circuit 15. The disabling circuit 15 compares the total consumed stream amount of “5” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “a” to the control circuit 13. The control circuit 13 confirms that the decoding disable signal is “0” and continues the process.

Fourth time: after confirming that the buffer circuit 11 does not have an underflow condition, the control circuit 13 generates a control signal for decoding a variable-length code. The decoding circuit 12 reads a leading portion of the stream in the buffer circuit 11, and outputs “2” which is the length of “10” as a consumed stream amount to the disabling circuit 15. The disabling circuit 15 compares the total consumed stream amount of “7” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “b” to the control circuit 13. The control circuit 13 confirms that the decoding disable signal is “0” and continues the process.

Fifth time: after confirming that the buffer circuit 11 does not have an underflow condition, the control circuit 13 generates a control signal for decoding a variable-length code. The decoding circuit 12 reads a leading portion of the stream in the buffer circuit 11, and outputs “7” which is the length of “1111111” as a consumed stream amount to the disabling circuit 15. The disabling circuit 15 compares the total consumed stream amount of “14” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “h” to the control circuit 13. The control circuit 13 confirms that the decoding disable signal is “0” and continues the process.

Sixth time: after confirming that the buffer circuit 11 does not have an underflow condition, the control circuit 13 generates a control signal for decoding a variable-length code. The decoding circuit 12 reads a leading portion of the stream in the buffer circuit 11, and outputs “3” which is the length of “110” as a consumed stream amount to the disabling circuit 15. The disabling circuit 15 compares the total consumed stream amount of “17” with the threshold of “16.” Because the total consumed stream amount is higher than the threshold, the disabling circuit 15 outputs “1” as the decoding disable signal. Because the decoding disable signal is “1,” the decoding circuit 12 outputs a control signal for stopping the iteration of the decoding process to the decoding circuit 12. As a result, the decoding circuit 12 stops the decoding process, and thereafter, the stream is not consumed. The control circuit 13 also performs a return process to end the task.

With this configuration, an error in a stream which causes a decoding process to be excessive compared to the normal level, can be detected. In this embodiment, if the total consumed stream amount exceeds the threshold, it is immediately detected that there is an error in a stream. Therefore, a long waiting time does not occur in detection of an error in a stream compared to the conventional art in which the time-out signal is output after the lapse of a long waiting time. If the processing performance of the control circuit (processor) 13 will be further improved in the future to increase the speed of a system, the decoding process can also be more quickly completed, whereby the time required for error detection can be further reduced.

In this embodiment, it is assumed that the length of a stream in a case where an error does not occur is stored in the header of the stream, and the correct stream length is available before a decoding process. Even if the correct stream length is not available before a decoding process, the configuration of this embodiment can be employed by using, as the threshold, the maximum value in a standard for a codec, or the maximum length in actual use.

### Second Embodiment

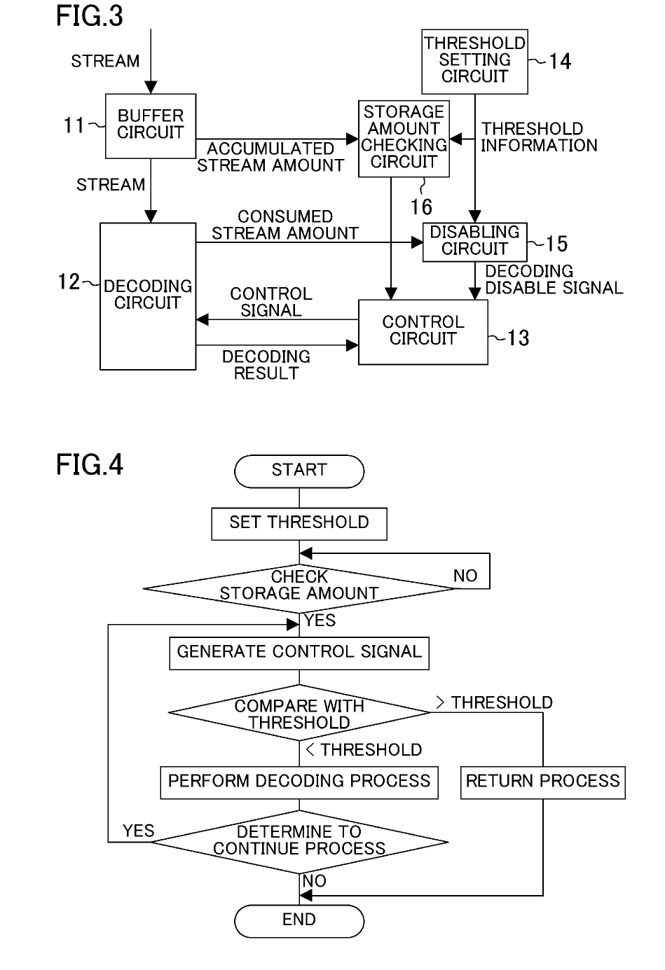

FIG. 3 is a block diagram showing a configuration of an encoded stream decoding device according to a second embodiment of the present disclosure. The configuration of the second embodiment is the same as that of the first embodiment, except that a storage amount checking circuit 16.

In FIG. 3, the storage amount checking circuit (storage amount checking section) 16 receives information about the amount of a stored stream from the buffer circuit 11, and a threshold from a threshold setting circuit 14. The stored stream amount is compared with the threshold. If the stored stream amount is higher than or equal to the threshold, the storage amount checking circuit 16 notifies the control circuit 13 of this.

FIG. 4 shows an example process flow of this configuration. After the threshold is set and thereafter the storage amount checking circuit 16 confirms that the amount of a stored stream in the buffer circuit 11 is higher than or equal to the threshold, the control circuit 13 generates the first control signal. The control circuit 13 causes the decoding circuit 12 to wait to perform a decoding process until the confirmation. Except for this difference, the second embodiment is the same as those of the first embodiment.

With this configuration, in a system in which the supply of a stream is unstable, it is possible to reduce or eliminate the possibility that an underflow occurs during a decoding process. Therefore, in a system in which the decoding circuit 12 returns an incorrect value when the amount of data is small (underflow) in a decoding process, the step of determining an underflow can be removed from the iterative decoding process. Also, in a system in which the decoding circuit 12 waits until the amount of a stored stream in the buffer circuit 11 becomes higher than or equal to the threshold when an underflow occurs, if an under flow occurs in a decoding process, the control circuit 13 waits until the amount of a stored stream in the buffer circuit 11 becomes higher than or equal to the threshold. With this configuration, an underflow can be prevented in a decoding process, and the control circuit 13 can be used to perform another task before the start of a decoding process until the amount of a stored stream in the buffer circuit 11 becomes higher than or equal to the threshold.

### Third Embodiment

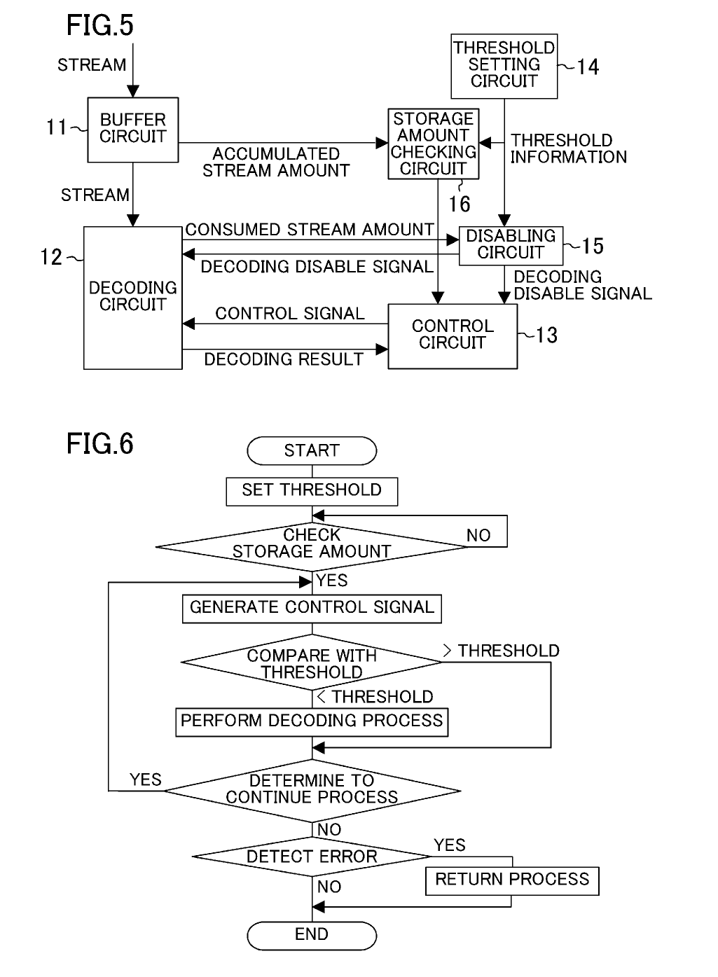

FIG. 5 is a block diagram showing a configuration of an encoded stream decoding device according to a third embodiment of the present disclosure.

The configuration of the third embodiment is different from that of the second embodiment in that the decoding disable signal generated by the disabling circuit 15 is also transmitted to the decoding circuit 12. It is also assumed that the required number of iterations of a decoding process is previously known.

FIG. 6 shows an example process flow of this configuration. Unlike the second embodiment, the control circuit 13 does not perform branching based on the decoding disable signal in a decoding process, and continues to generate a control signal for causing the decoding process to continue regardless of the decoding disable signal. The decoding circuit 12, when the decoding disable signal is enabled (i.e., “1”), receives a control signal generated by the control circuit 13, and outputs a special value of “0” as a decoding result to the control circuit 13 without performing a decoding process. In other words, the decoding circuit 12 behaves as if it performed a decoding process after receiving the control signal. In this case, the decoding circuit 12 may shut down a clock, a power supply, etc. in order to reduce power consumption of an unnecessary circuit. The control circuit 13, when the decoding disable signal is enabled after the final iteration of the decoding process is ended, performs a control for a return process.

A case where a stream “0110010101111111” is erroneously input as “0110011111111111(0)” will be described, assuming that the stream is decoded based on the encoding table of FIG. 12. Here, the 17th bit is a stream following an original stream to be decoded.

Initially, the threshold setting circuit 14 stores a threshold received externally or from the control circuit 13. It is assumed that a stream having a length of 16 bits is externally input, and the value of “16” is set as the threshold. Next, after the storage amount checking circuit 16 confirms that the amount of a stored stream in the buffer circuit 11 is higher than or equal to the threshold, the control circuit 13 starts iterating a decoding process. The control circuit 13 is assumed to previously know that the decoding process is completed by six iterations of the decoding process.

First time: the control circuit 13 generates a control signal for decoding a variable-length code. The decoding circuit 12 reads a leading portion of the stream in the buffer circuit 11, and outputs “1” which is the length of “0” as a consumed stream amount to the disabling circuit 15. The disabling circuit 15 compares the total consumed stream amount of “1” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “a” to the control circuit 13. The control circuit 13 continues the process regardless of the decoding disable signal.

Second time: the control circuit 13 generates a control signal for decoding a variable-length code. The decoding circuit 12 reads a leading portion of the stream in the buffer circuit 11, and outputs “3” which is the length of “110” as a consumed stream amount to the disabling circuit 15. The disabling circuit 15 compares the total consumed stream amount of “4” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “c” to the control circuit 13. The control circuit 13 continues the process regardless of the decoding disable signal.

Third time: the control circuit 13 generates a control signal for decoding a variable-length code. The decoding circuit 12 obtains a stream “0” from the buffer circuit 11. The decoding circuit 12 outputs “1” which is a consumed stream amount to the disabling circuit 15. The disabling circuit 15 compares the total consumed stream amount of “5” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “a” to the control circuit 13. The control circuit 13 continues the process regardless of the decoding disable signal.

Fourth time: the control circuit 13 generates a control signal for decoding a variable-length code. The decoding circuit 12 reads a leading portion of the stream in the buffer circuit 11, and outputs “7” which is the length of “1111111” as a consumed stream amount to the disabling circuit 15. The disabling circuit 15 compares the total consumed stream amount of “12” with the threshold of “16.” Because the total consumed stream amount is lower than or equal to the threshold, the disabling circuit 15 outputs “0” as the decoding disable signal. Because the decoding disable signal is “0,” the decoding circuit 12 performs a decoding process, and outputs the decoding result “h” to the control circuit 13. The control circuit 13 continues the process regardless of the decoding disable signal.

Fifth time: the control circuit 13 generates a control signal for decoding a variable-length code. The decoding circuit 12 reads a leading portion of the stream in the buffer circuit 11, and outputs “5” which is the length of “11110” as a consumed stream amount to the disabling circuit 15. The disabling circuit 15 compares the total consumed stream amount of “17” with the threshold of “16.” Because the total consumed stream amount is higher than the threshold, the disabling circuit 15 outputs “1” as the decoding disable signal. Because the decoding disable signal is “1,” the decoding circuit 12 does not perform a decoding process, and outputs “0” as the decoding result. The control circuit 13 continues the process regardless of the decoding disable signal.

Sixth time: the control circuit 13 generates a control signal for decoding a variable-length code. Because the decoding disable signal is “1,” the decoding circuit 12 does not perform a decoding process, and outputs “0” as the decoding result.

In the configuration of this embodiment, the control circuit 13 does not need to determine whether the value of the decoding disable signal is “0” or “1” in each iteration of a decoding process. An external input stream typically frequently has no error. The process which the control circuit 13 needs to perform in each iteration of a decoding process can be removed for a stream which has no error. For example, the control circuit 13 may only need to abandon one task including an error if the decoding disable signal is finally “1.”

### Fourth Embodiment

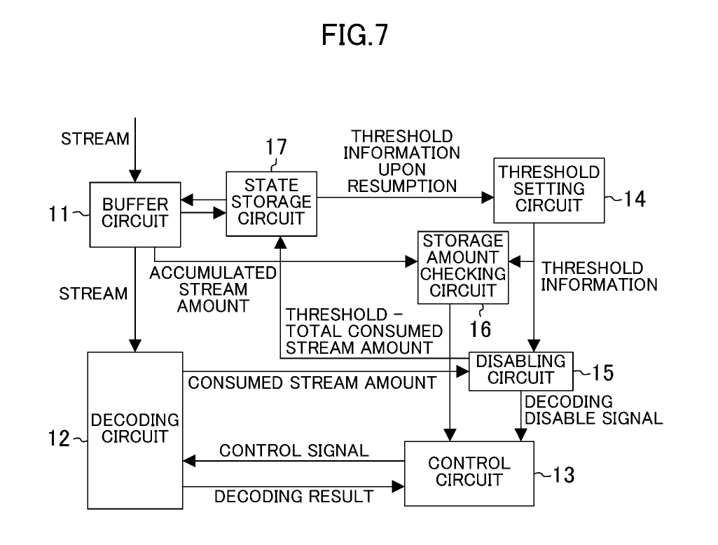

FIG. 7 is a block diagram showing a configuration of an encoded stream decoding device according to a fourth embodiment of the present disclosure.

The configuration of the fourth embodiment is different from that of the first embodiment in that a state storage circuit 17 is provided. The state storage circuit (state storage section) 17 stores the difference between a threshold input from the disabling circuit 15 and the total amount of a consumed stream (the threshold—the total consumed stream amount), and a state of a stream in the buffer circuit 11. The state storage circuit 17 also notifies the threshold setting circuit 14 of the stored difference between the threshold and the total consumed stream amount, and restores the state of the stream in the buffer circuit 11.

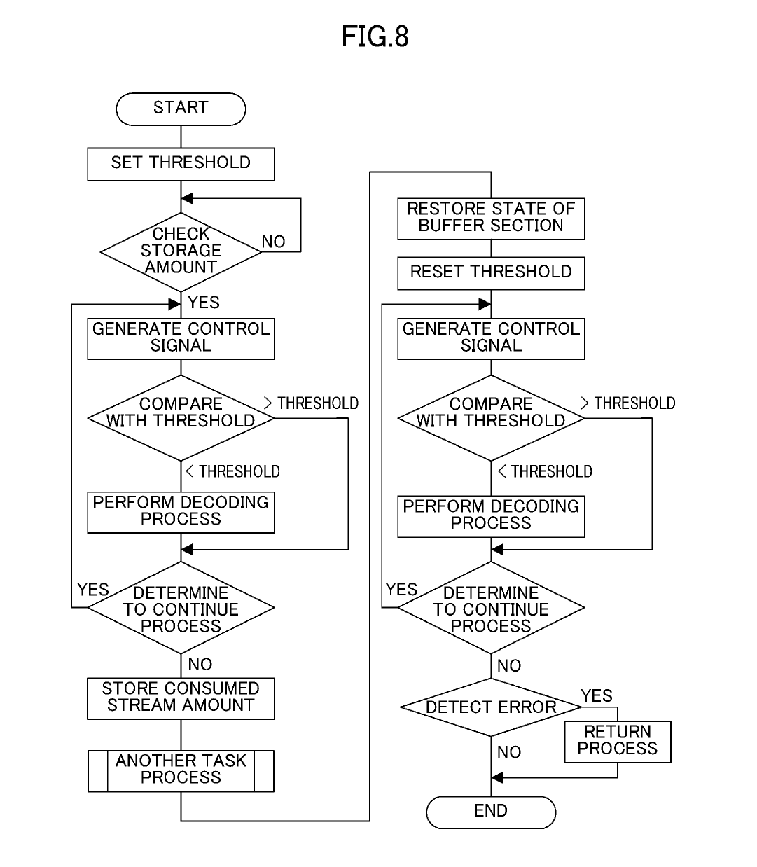

FIG. 8 shows an example process flow of this configuration. Unlike the third embodiment, the control circuit 13 can perform a control for interrupting a decoding process when determining whether to continue the decoding process. When the decoding process is interrupted, the state storage circuit 17 stores the difference between the threshold input from the disabling circuit 15 and the total consumed stream amount, and the stream state of the buffer circuit 11 obtained from the buffer circuit 11, immediately after the control circuit 13 determines whether to continue the process. When decoding is resumed, the stream state of the buffer circuit 11 is restored, the stored difference between the threshold and the total consumed stream amount is transmitted as a new threshold to the threshold setting circuit 14, and the interrupted process is resumed.

For example, in an example of the first embodiment where there is not an error in a stream, if processing is interrupted after the fourth iteration of the decoding process, the state storage circuit 17 stores “9” which is the difference between the threshold of “16” and the total consumed stream amount of “7,” and a stream state stored by the buffer circuit 11, such as a pointer indicating the head of the stream. Thereafter, when the decoding process is resumed, “9” is set as a new threshold into the threshold setting circuit 14, a pointer is set into the buffer circuit 11, and a stream is input to the buffer circuit 11 if necessary, and the decoding process is resumed from the fifth iteration of the decoding process.

If the control circuit 13 is implemented by a processor which also executes a task other than a decoding process, then when processing may be switched to another task partway through the decoding process, a more complicated system can be configured.

When decoding is resumed, a stream can be skipped or rewound by changing and restoring the difference between the threshold and the total consumed stream amount and the stream state of the buffer circuit 11.

### Fifth Embodiment

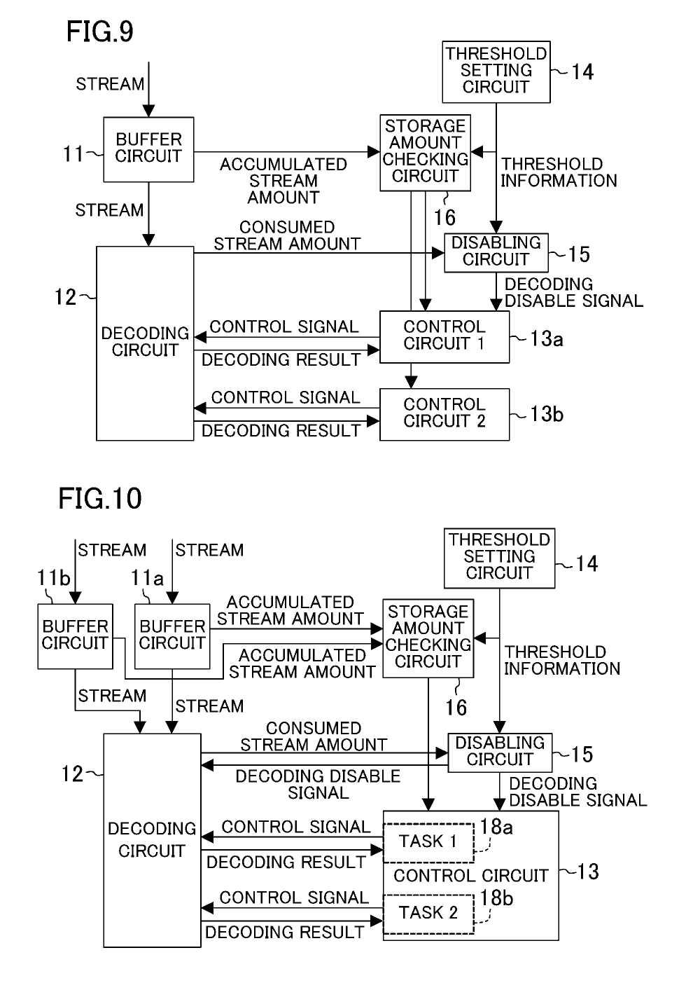

FIG. 9 is a block diagram showing a configuration of an encoded stream decoding device according to a fifth embodiment of the present disclosure.

The configuration of the fifth embodiment is different from that of the first embodiment in that a control circuit 13a and another control circuit (second control section) 13b are provided. In this configuration, the decoding circuit 12 normally receives only a control signal generated by one (e.g., 13a) of the control circuits until a task which is being executed by the control circuit 13a is ended or processing is interrupted by the method of the fourth embodiment. However, after the decoding disable signal is enabled (i.e., “1”), the decoding circuit 12 does not need to perform decoding in the current task, and therefore, receives only a control signal generated by the other control circuit 13b.

FIG. 10 shows a configuration in which a single control circuit 13 performs a plurality of tasks 18a and 18b in parallel. Also in this case, when a control signal is output in each of the tasks 18a and 18b, an identification signal for distinguishing one task from another is output, whereby the tasks can be processed in a manner similar to when a plurality of control circuits are provided.

### Sixth Embodiment

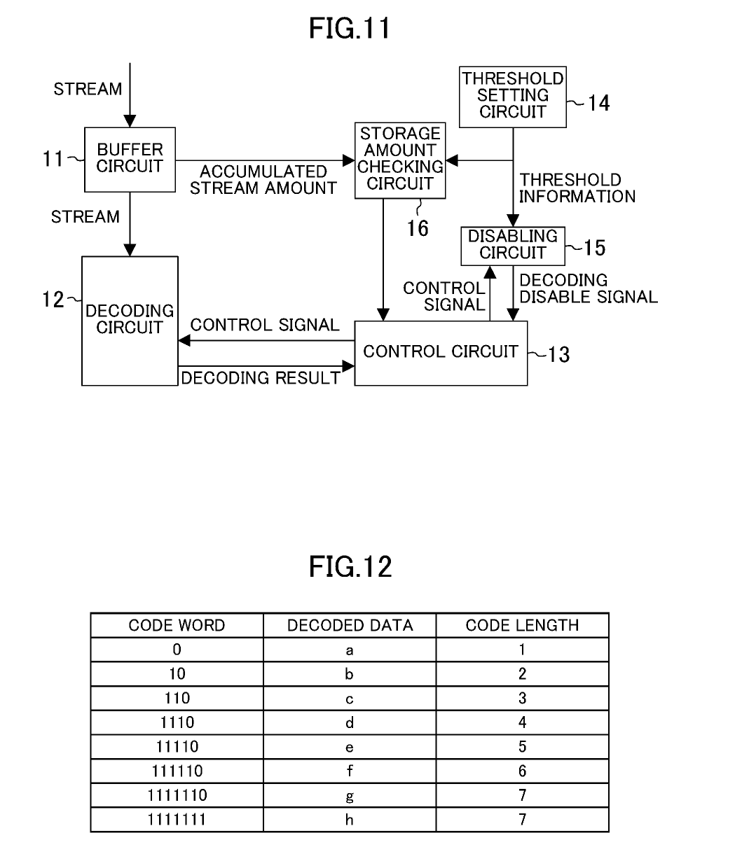

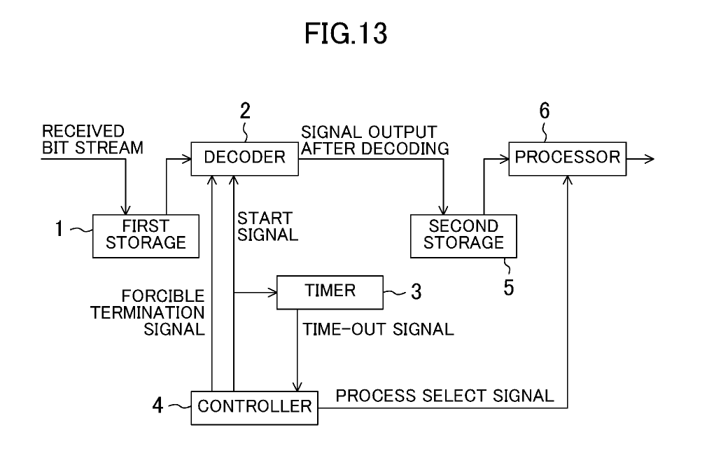

FIG. 11 is a block diagram showing a configuration of an encoded stream decoding device according to a sixth embodiment of the present disclosure.

The encoded stream decoding device of FIG. 11 includes a buffer circuit 11, a decoding circuit 12, a control circuit 13, a threshold setting circuit 14, a disabling circuit 15, and a storage amount checking circuit 16.

The buffer circuit 11 stores an external input stream for the preparation of a decoding process. The decoding circuit 12 decodes a stream input from the buffer circuit 11 based on a control signal, and outputs the decoding result. The control circuit 13 generates a control signal for controlling the decoding circuit 12, and receives the result of the control.

The threshold setting circuit (threshold setting section) 14 outputs, to the disabling circuit 15, a threshold which has been set therein externally or by the control circuit 13. The threshold is for the number of times of generation of a control signal by the control circuit 13, i.e., for the number of iterations of a decoding process.

The disabling circuit 15 compares the number of times of generation of a control signal by the control circuit 13 with a threshold from the threshold setting circuit 14. When the number of times of generation of a control signal exceeds the threshold, the disabling circuit 15 enables the decoding disable signal. The storage amount checking circuit 16 receives information about the amount of a stored stream from the buffer circuit 11, and if the stored stream amount is higher than or equal to a predetermined value, notifies the control circuit 13 of this.

In the configuration of this embodiment, a control similar to that of the second embodiment of FIG. 4 can be performed.

A case where a stream is erroneously input as “0110011111111111(0)” instead of “0110010101111111” will be described, assuming that the stream is decoded based on the encoding table of FIG. 12. Here, the 17th bit is a stream following an original stream to be decoded. It is also assumed that when the decoding result is “h,” one task of a decoding process is completed.

Initially, the threshold setting circuit 14 stores a threshold received externally or from the control circuit 13. Here, it is assumed that “6” is externally input as the normal number of times of generation of a control signal (the normal number of iterations of a decoding process), and the value of “6” is set as the threshold. Next, after the storage amount checking circuit 16 confirms that the amount of a stored stream in the buffer circuit 11 is higher than or equal to the threshold, the control circuit 13 starts iterating a decoding process.

First time: the control circuit 13 generates a control signal for decoding a variable-length code. The disabling circuit 15 compares the control signal generation number of “1” with the threshold of “6.” Because the control signal generation number is lower than or equal to the threshold, the disabling circuit 15 outputs “0” as the decoding disable signal. Because the decoding disable signal is “0,” the decoding circuit 12 performs a decoding process, and outputs the decoding result “a” to the control circuit 13. Because the decoding result is not “h,” the control circuit 13 continues the process.

Second time: the control circuit 13 generates a control signal for decoding a variable-length code. The disabling circuit 15 compares the control signal generation number of “2” with the threshold of “6.” Because the total control signal generation number is lower than or equal to the threshold, the disabling circuit 15 outputs “0” as the decoding disable signal. Because the decoding disable signal is “0,” the decoding circuit 12 performs a decoding process, and outputs the decoding result “c” to the control circuit 13. Because the decoding result is not “h,” the control circuit 13 continues the process.

Third time: the control circuit 13 generates a control signal for decoding a variable-length code. The disabling circuit 15 compares the control signal generation number of “3” with the threshold of “6.” Because the total control signal generation number is lower than or equal to the threshold, the disabling circuit 15 outputs “0” as the decoding disable signal. Because the decoding disable signal is “0,” the decoding circuit 12 performs a decoding process, and outputs the decoding result “a” to the control circuit 13. Because the decoding result is not “h,” the control circuit 13 continues the process.

Fourth time: the control circuit 13 generates a control signal for decoding a variable-length code. The disabling circuit 15 compares the control signal generation number of “4” with the threshold of “6.” Because the total control signal generation number is lower than or equal to the threshold, the disabling circuit 15 outputs “0” as the decoding disable signal. Because the decoding disable signal is “0,” the decoding circuit 12 performs a decoding process, and outputs the decoding result “b” to the control circuit 13. Because the decoding result is not “h,” the control circuit 13 continues the process.

Fifth time: the control circuit 13 generates a control signal for decoding a variable-length code. The disabling circuit 15 compares the control signal generation number of “5” with the threshold of “6.” Because the total control signal generation number is lower than or equal to the threshold, the disabling circuit 15 outputs “0” as the decoding disable signal. Because the decoding disable signal is “0,” the decoding circuit 12 performs a decoding process, and outputs the decoding result “b” to the control circuit 13. Because the decoding result is not “h,” the control circuit 13 continues the process.

Sixth time: the control circuit 13 generates a control signal for decoding a variable-length code. The disabling circuit 15 compares the control signal generation number of “6” with the threshold of “6.” Because the total control signal generation number is lower than or equal to the threshold, the disabling circuit 15 outputs “0” as the decoding disable signal. Because the decoding disable signal is “0,” the decoding circuit 12 performs a decoding process, and outputs the decoding result “b” to the control circuit 13. Because the decoding result is not “h,” the control circuit 13 continues the process.

Seventh time: the control circuit 13 generates a control signal for decoding a variable-length code. The disabling circuit 15 compares the control signal generation number of “7” with the threshold of “6.” Because the total control signal generation number is higher than the threshold, the disabling circuit 15 outputs “1” as the decoding disable signal. Because the decoding disable signal is “1,” the control circuit 13 outputs a control signal for stopping the decoding process, and as a result, the decoding circuit 12 does not performs a decoding process. Thereafter, the control circuit 13 ends the process.

While, in this embodiment, a configuration including the storage amount checking circuit 16 has been described, the present disclosure is, of course, applicable to the first embodiment which does not include the storage amount checking circuit 16. Needless to say, this embodiment may be combined with the third to fifth embodiments.

As described above, the encoded stream decoding device of the present disclosure can detect an error in a stream without waiting for a long time, and therefore, is useful for applications, such as an audio or video decoding device employing an advanced encoding technique, a communication device employing a variable-length code, etc.

What is claimed is:

1. An encoded stream decoding device comprising:
a buffer section configured to store an external input stream;
a decoding section configured to variable-length decode the stream stored in the buffer section;
a control section configured to generate a control signal for controlling operation of the decoding section, and output the control signal to the decoding section;
a threshold setting section configured to store a threshold for a stream consumed by the decoding section; and
a disabling section configured to generate a decoding disable signal based on the threshold in the threshold setting section and the amount of the stream consumed by the decoding section, and output the decoding disable signal to the control section.

2. The encoded stream decoding device of claim 1, further comprising:
a storage amount checking section configured to confirm that a sufficient amount of stream for the threshold stored by the threshold setting section has been stored in the buffer section,
wherein
the control section causes the decoding section to wait until the storage amount checking section confirms that the sufficient amount of stream for the threshold stored by the threshold setting section has been stored in the buffer section.

3. The encoded stream decoding device of claim 1, wherein
the control section, when receiving the decoding disable signal from the disabling section, stops decoding operation of the decoding section using the control signal, and
the decoding section, when the disabling section is generating the decoding disable signal, stops a decoding process based on the control signal from the control section, so that the decoding section does not consume the stream.

4. The encoded stream decoding device of claim 1, wherein
the control section, even when receiving the decoding disable signal from the disabling section, generates a control signal which causes the decoding section to continue decoding, and
the decoding section receives the decoding disable signal generated by the disabling section, and behaves as if the decoding section received the control signal generated by the control section and operated based on the control signal, for the control section, when the decoding section is receiving the decoding disable signal.

5. The encoded stream decoding device of claim 4, wherein
when the decoding section is receiving the decoding disable signal from the disabling section, the decoding section does not perform a decoding process, and generates a special value as a decoding result and outputs the decoding result having the special value to the control section.

6. The encoded stream decoding device of claim 4, wherein
the decoding section reduces power consumption by shutting down a clock or the like when the decoding section is receiving the decoding disable signal.

7. The encoded stream decoding device of claim 5, wherein
the control section, after ending a task including a series of decoding processes, determines whether or not the disabling section is generating the decoding disable signal, and when the disabling section is generating the decoding disable signal, performs a control for returning.

8. The encoded stream decoding device of claim 3, further comprising:
a state storage section configured to be notified of a difference between the threshold in the threshold setting section and the total amount of a stream consumed by the decoding section, by the disabling section, and also notified of a state of a stream in the buffer section by the buffer section,
wherein
after a decoding process is interrupted in the decoding section, when the interrupted decoding process is resumed, the state storage section notifies the threshold setting section of the difference between the threshold and the total consumed stream amount as a new threshold, and restores the stream state in the buffer section.

9. The encoded stream decoding device of claim 8, wherein
the state storage section changes the difference between the threshold and the total consumed stream amount and notifies the threshold setting section of the difference, and changes the stream state in the buffer section so that the stream state corresponds to the changed difference, thereby rewinding or skipping the stream.

10. The encoded stream decoding device of claim 3, further comprising:
a second control section configured to generate a second control signal for controlling the decoding section, and outputs the second control signal to the decoding section,
wherein
the decoding section performs a decoding process based on a control signal from the second control section when the decoding section is receiving the decoding disable signal from the disabling section.

11. The encoded stream decoding device of claim 3, wherein
the control section controls a plurality of tasks in parallel, and
the decoding section, when performing a decoding process based on one of the plurality of tasks, performs a decoding process of another task when the decoding section is receiving the decoding disable signal from the disabling section.

12. An encoded stream decoding device comprising:
a buffer section configured to store an external input stream;
a decoding section configured to variable-length decode the stream stored in the buffer section;
a control section configured to generate a control signal for controlling operation of the decoding section, and output the control signal to the decoding section;
a threshold setting section configured to store a threshold for the number of times of generation of the control signal by the control section; and
a disabling section configured to generate a decoding disable signal based on the threshold in the threshold setting section and the number of times of generation of the control signal by the control section, and output the decoding disable signal to the control section.

13. The encoded stream decoding device of claim 12, further comprising:
a storage amount checking section configured to confirm that a predetermined amount of stream has been stored in the buffer section,
wherein
the control section causes the decoding section to wait until the storage amount checking section confirms that the predetermined amount of stream has been stored in the buffer section.

14. The encoded stream decoding device of claim 12, wherein
the control section, when receiving the decoding disable signal from the disabling section, stops decoding operation of the decoding section based on the control signal, and
the decoding section, when the disabling section is generating the decoding disable signal, receives the control signal from the control section and stops a decoding process, so that the decoding section does not consume the stream.
